(19) United States
(12) Patent Application Publication
(10) Pub. No.: US 2025/0012147 A1
(43) Pub. Date: Jan. 9, 2025

(54) LADDER SADDLE

(71) Applicants: Darin Samuel Woldman, Calabasas, CA (US); Tanner Woldman, Calabasas, CA (US)

(72) Inventors: Darin Samuel Woldman, Calabasas, CA (US); Tanner Woldman, Calabasas, CA (US)

(21) Appl. No.: 18/445,312

(22) Filed: Jul. 3, 2023

(51) Int. Cl. E06C 7/14

(52) U.S. Cl. CPC E06C 7/14

(57) ABSTRACT

A sewn tool bag that fits on top of an A-Frame ladder creating a safe, organized, and efficient process for using and storing hand tools and fasteners on job sites.

### FIELD

The present application relates to a sewn tool bag for safely organizing hand tools and miscellaneous construction items on top of a ladder creating an entirely more efficient work process.

### BACKGROUND

The Ladder Saddle started as a means to eliminate unnecessary movements created by going up and down a work ladder. The Ladder Saddle is versatile and is designed to fit on to ladders of any height. When tools are organized on top of the ladder the worker is allowed to work freely and safely. The Ladder Saddle is made to eliminate hazards such as dropping tools from ladders. The Ladder Saddle keeps the tools off of the user and allows for organization for jobs that include many different parts. The current ladders on market do not safely secure the tools and fasteners required for most construction jobs. The Ladder Saddle is designed with deep pockets to secure loose parts during the work process. The Ladder Saddle has a uniquely designed holster that full encapsulates drills, screw guns, and caulking guns. The intent of this product is to encourage job site productivity, safety, and organization while on ladders.

### SUMMARY

The Ladder Saddle is a sewn product made for safely and easily organizing tools on ladders. The product has five sides each designed with specific pockets intended for hand tools and fasteners. The Ladder Saddle sits on top of A-Frame ladders of any height. The Ladder Saddle eliminates many of the problems related to working on ladders. The Ladder Saddle organizes hand tools and helps to eliminate most drops from working up high. The Ladder Saddle eliminates the need for workers to wear personal hip tool bags on ladders. By placing all the tools into the Ladder Saddle the worker can move about the ladder with more range of motion. The product features a uniquely designed number of pockets, tool pockets, and holsters.

### BRIEF DESCRIPTION OF THE DRAWINGS

Circled Numbers in the drawings indicate seams. All measurements are in inches.

FIG. 1 represents a top and side view of the handle with shown seams 1 and 2. Dotted X lines indicate heavy-duty reinforcing stitch location.

FIG. 2 a top view of the unit's Top Panel with seams 3, 4, 5, 6.

FIG. 3 a flat view of the Deep Pocket Panel with seams 7, 8, 9, 10.

FIG. 4 a flat view of the Hand-Held Tool Panel with seams 11, 12, 13, 14.

FIG. 5 a flat view of the Deep Pocket that attaches to FIG. 3 with seams 15, 16, 17, 18, 19, 20, 21, 22, 23, 24. Dotted lines indicate fold lines to create a pocket.

FIG. 6 a flat view of the Secondary Deep Pockets that attach to FIG. 4 with seams 25, 26, 27, 28, 29, 30, 31, 32, 33, 34. Dotted lines indicate fold lines to create a pocket.

FIG. 7 a flat view of the Hammer Holster Panel with seams 35, 36, 37, 38.

FIG. 8 a flat view of the Utility Knife Panel with seams 39,40, 41, 42.

FIG. 9 the top drawing are the Hand-Held Tool Pockets in their configuration. The bottom drawing is a flat view of the Hand-Held Tool Pockets. Both show seams 43, 44, 45, 46. Also shown are internal seams A, B, C.

FIG. 10 a flat view of a Holster panel with seams 71, 72, 100, 101.

FIG. 11 a flat view of a Holster panel with seams 73,74, 102, 103.

FIG. 12 the top drawing are the Hammer Loops in their configuration. The bottom is flat view of the Hammer Loops. Both show seams 68, 69, 70.

FIG. 13 the top drawing is the Hand-Held Tool Pocket Reinforcement Band in its configuration. The bottom drawing is a flat view of the Hand-Held Tool Pocket Reinforcement Band. Both drawings show seams 63, 64 and D, E, and F.

FIG. 14 a flat view of the Deep Pocket Divider with seams 47, 48, 49, 50.

FIG. 15 a flat view of the Deep Pocket Divider with seams 51, 52, 53, 54.

FIG. 16 a flat view of the Deep Pocket Divider with seams 55, 56, 57, 58.

FIG. 17 a flat view of the Deep Pocket Divider with seams 59,60, 61, 62.

FIG. 18 the top drawing is the Reinforcement Band in its configuration. The bottom drawing is a flat view of Reinforcement Band with seams 81 and 82.

FIG. 19 the top drawing is the Reinforcement Band in its configuration. The bottom drawing is a flat view of Reinforcement Band with seams 79 and 80.

FIG. 20 a flat view of the Reinforcement Band for the Deep Pocket Dividers.

FIG. 21 a flat view of the Reinforcement Band for the Deep Pocket Dividers.

FIG. 22 a flat view of the Reinforcement Band for the Deep Pocket Dividers.

FIG. 23 a flat view of the Reinforcement Band for the Deep Pocket Dividers.

FIG. 24 a flat view of Heavy Duty Top Banding with seams 77 and 78.

FIG. 25 a flat view of Heavy Duty Top Banding with seams 75 and 76.

FIG. 26 a flat view of Heavy Duty Top Banding.

FIG. 27 a flat view of Heavy Duty Top Banding.

FIG. 28 a flat view of Utility Knife Pocket with seams 83, 84, 88.

FIG. 29 a flat view of Utility Knife Pocket with seams 85, 86, 87.

FIG. 30 view of Utility Knife Pocket Reinforcement Band.

FIG. 31 view of Utility Knife Pocket Reinforcement Band.

FIG. 32 a flat view of the Reinforcement Band for Top of Holster.

FIG. 33 a flat view of the Reinforcement Band for Top of Holster.

FIG. 34 a flat view of the Reinforcement Band for Bottom of Holster.

FIG. 35 a flat view of the Reinforcement Band for Bottom of Holster.

FIG. 36 a flat view of the Perimeter Reinforcement Band for the FIG. 29 Utility Knife Pocket.

FIG. 37 a flat view of the Perimeter Reinforcement Band for the FIG. 28 Utility Knife Pocket.

FIG. 38 a flat view of the Reinforcement Band for the side of the Holster on FIG. 11.

FIG. 39 a flat view of the Reinforcement Band for the side of the Holster on FIG. 11.

FIG. 40 a flat view of the Reinforcement Band for FIG. 5.

FIG. 41 a flat view of the Reinforcement Band for FIG. 6.

FIG. 42 a flat view of the Reinforcement Band for the side of the Holster on FIG. 10.

FIG. 43 a flat view of the Reinforcement Band for the side of the Holster on FIG. 10.

FIG. 44 a flat view of the Reinforcement Band for the bottom of the completed Ladder Saddle.

FIG. 45 a completed view of the Deep Pocket Panel with transparent views of internal dividers. Shown are FIGS. 3, 5, 14, 15, 16, 19, 20, 21, 22, 26, 40.

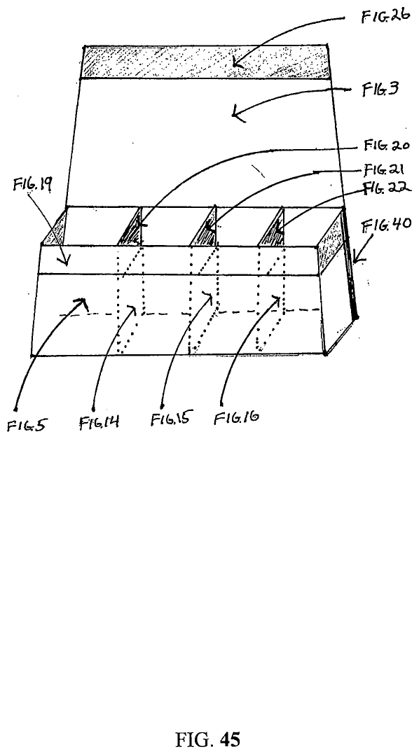

FIG. 46 a completed view of the Hand-Held Tool Panel with transparent views of the tool pockets and central divider. Shown are FIGS. 4, 6, 9, 13, 17, 18, 23, 27, 41.

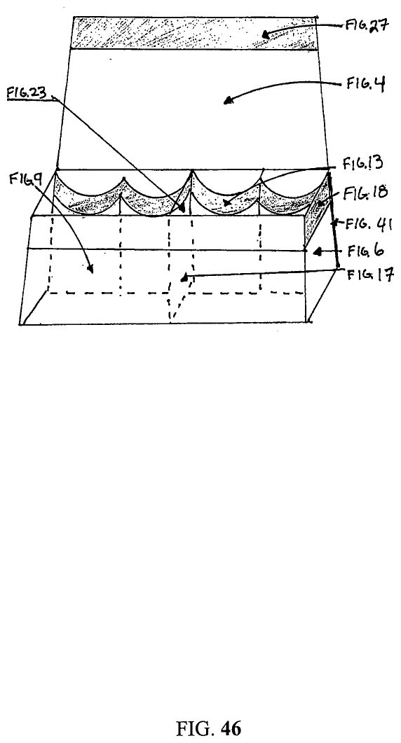

FIG. 47 a completed view of the Hammer Holster Panel with FIGS. 7, 11, 12, 25, 33, 35, 38, 39, 44. The dotted X indicates a heavy duty reinforcement stitch with seams 68, 69, 70.

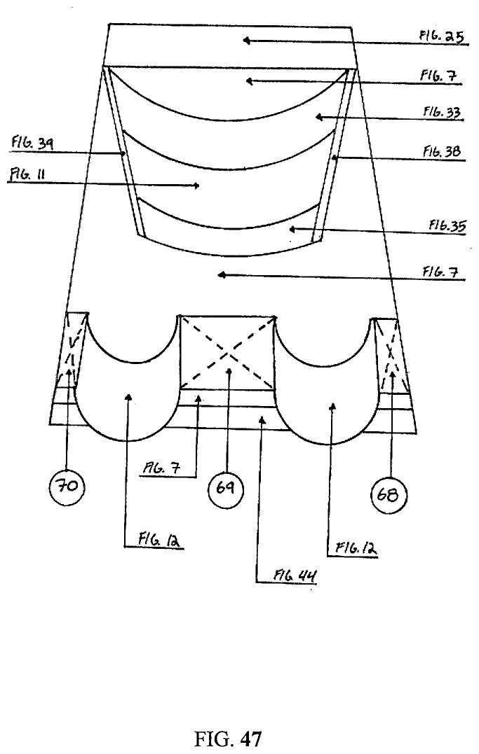

FIG. 48 a completed view of the Utility Knife Pocket Panel. Shown are FIGS. 8, 10, 24, 28, 29, 30, 31, 32, 36, 37, 42, 43, 44.

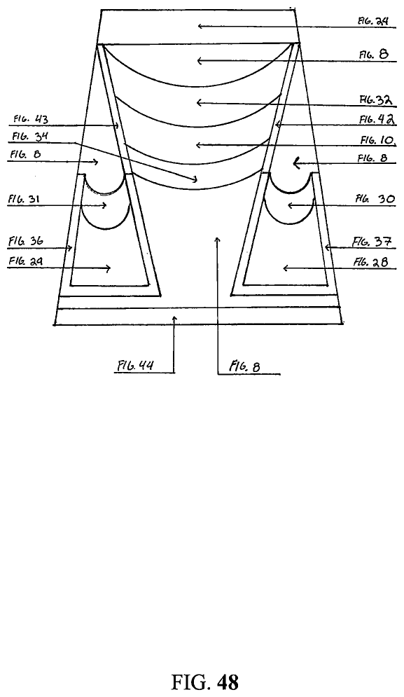

FIG. 49 a top view of the completed Top Panel with FIGS. 1, 2, 24, 25, 26, 27. This view shows the top view with a handle and the 2″ reinforcement band forming a tray for construction items to prevent rolling off. The two Xs indicate heavy duty stitching areas for the handle.

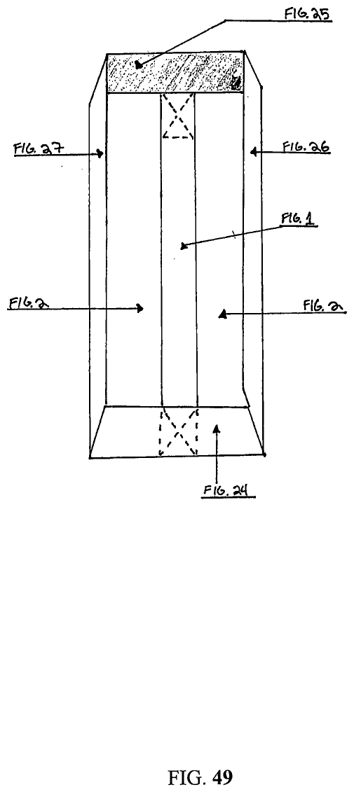

FIG. 50 a top view of the completed Ladder Saddle with corresponding FIGURES. This view exposes the Hammer Holster Panel.

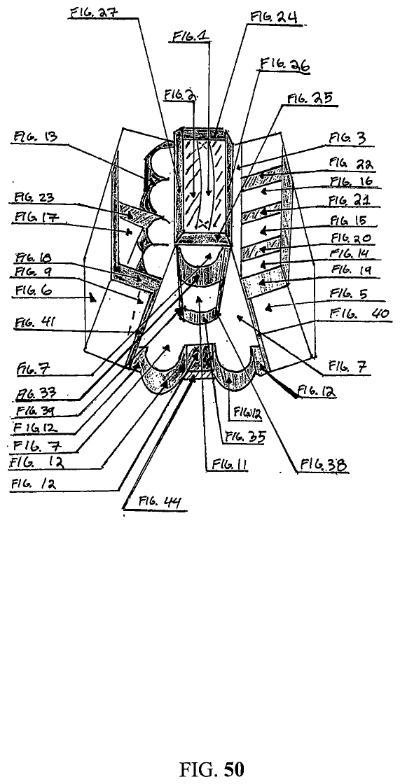

FIG. 51 a top view of the completed Ladder Saddle with corresponding FIGURES. This view exposes the Utility Knife Panel.

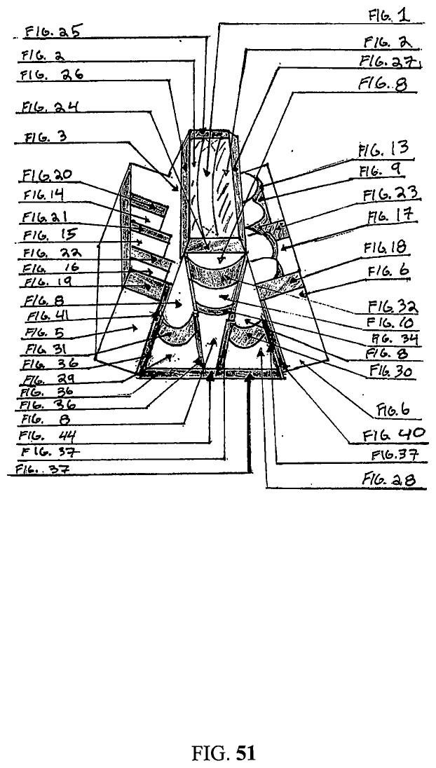

FIG. 52 a flat view of the Interior Reinforcement Band.

FIG. 53 a flat view of the Interior Reinforcement Band.

FIG. 54 a flat view of the Interior Reinforcement Band.

FIG. 55 a flat view of the Interior Reinforcement Band.

FIG. 56 an underneath view of the completed Ladder Saddle to expose the internal Reinforcement Bands showing FIGS. 52, 53, 54, 55. Also shown is the foam insert in dotted lines and the secondary inside panel with FIGS. 59 and 60. Listed are double seams (6, 37), (10, 36), (3, 11), (8, 42), (4, 41), (14, 40), (5, 7), (12, 38). FIG. 44 is also shown around the bottom perimeter of the Ladder Saddle.

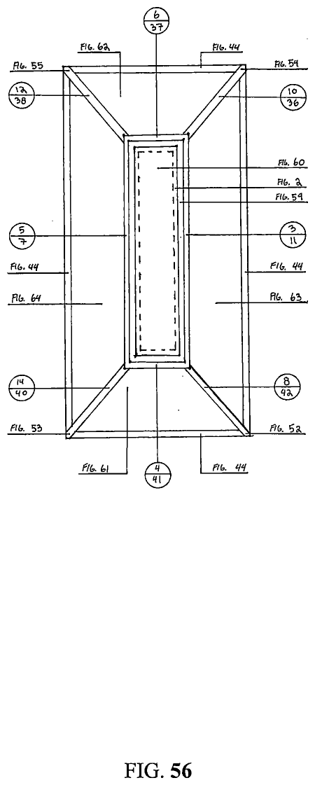

FIG. 57 a flat view of the completed panels with according attachment seams. This view indicates the necessary seams for adjoining all the primary panels of the Ladder Saddle.

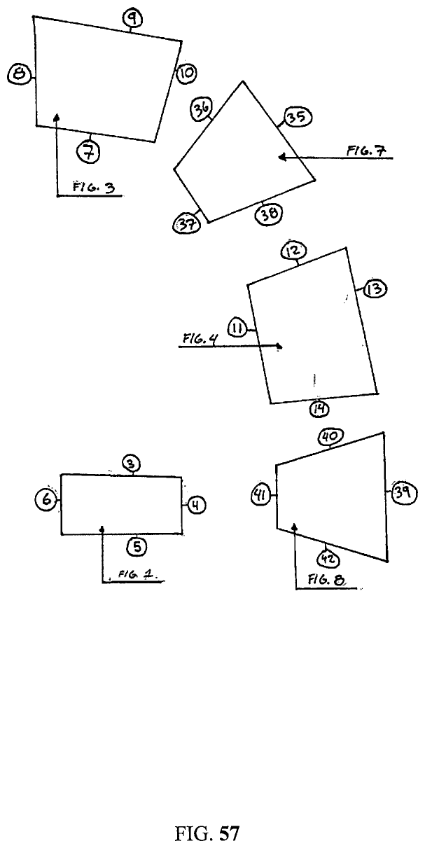

FIG. 58 a top view of the adjoining seams for the 2″ top reinforcement bands showing the seams 75, 76, 77, and 78. Shown are FIGS. 59, 60, 24, 25, 26, 27. Double seams (6, 37), (3, 11), (4, 41), (5, 7).

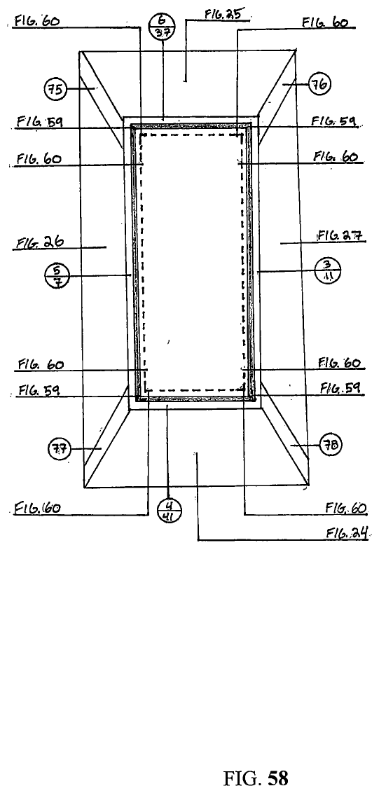

FIG. 59 a view of the secondary inside top panel that encapsulates the foam insert. Shown are seams 200, 201, 202, 203.

FIG. 60 a view of the foam insert for the top panel.

FIG. 61 a flat view of a secondary interior panel with seams 204, 205, 206, 207.

FIG. 62 a flat view of a secondary interior panel with seams 208, 209, 210, 211.

FIG. 63 a flat view of a secondary interior panel with seams 212, 213, 214, 215.

FIG. 64 a flat view of the secondary interior panel with seams 216, 217, 218, 219.

FIG. 65 a flat view of secondary holster panel reinforcement with seams 150, 151, 152, 153.

FIG. 66 a flat view of secondary holster panel reinforcement with seams 154, 155, 156, 157.

### DETAILED DESCRIPTION

The Ladder Saddle is a uniquely designed sewn tool bag that fits on top of A-Frame ladders. The product was invented in order to create a tool bag that rests on top of work ladders and allows for a convenient, safe, and organized method of storing hand-tools and fasteners for construction related tasks. The Ladder Saddle eliminates unwanted trips up and down ladders. This leads to more efficiency from workers and less strain on workers' physical bodies. By storing tools and fasteners up on top of the ladder allows for an increased level of convenience on the job site.

The Ladder Saddle can be made from various materials, but the best results are achieved when using ballistic nylon 1680 denier. The ballistic nylon material gives the the Ladder Saddle rigidity, durability, and allows the product to be able to be stored easily. The Ladder Saddle is designed with specific measurements and dimensions that are listed in the drawings section. These measurements are meant to facilitate the assembly process and contribute to the unique size of the tool bag's pockets that are sized to enable maximum efficiency by the product's user. The process for assembly is done by sewing of the mention parts to the corresponding panels and then sewing all of the panels together. The Ladder Saddle is composed of four sides and a top panel. The Deep Pocket Panel, the Hammer Holster Panel, the Utility Knife Panel, the Hand-Held Tool Panel, and the Top Panel.

The Deep Pocket Panel is composed of a main trapezoidal panel and three dividers that create four equal sized pockets. A main pocket attaches to the dividers and trapezoidal panel. Every central divider, the main pocket, and the outside edges are reinforced with 2″ ballistic nylon to prevent excessive wear from use. A total of four deep pockets will complete this panel.

The Hammer Holster Panel is built using a main trapezoidal panel, the holster piece, hammer loops, and corresponding reinforcement bands. The holster panel is attached to the trapezoidal panel and reinforcements bands are sewn on to the vertical seams as well as the bottom and top of the holster. Below will attach the hammer loops at the bottom of this panel creating a total of two loops. The holster is uniquely designed to fully hold the screw gun, drill, or caulking gun in use. The holster is unique because it securely wraps around the tool in use helping prevent falls. The holster panel will be doubled up for rigidity and durability.

The Utility Knife Panel is composed of a main trapezoidal panel, a holster, two utility knife pockets, and the corresponding reinforcement bands. The holster attaches to the top of this panel. The two utility pockets go at the bottom to the left and right side. Reinforcement bands attach to the vertical and horizontal seams of the holster. Around the seams of the utility knife pockets get reinforcement bands on the top and around the perimeter of the pockets. The holster panel is doubled up on material for durability.

The Hand-Held Tool Panel is comprised of a trapezoidal panel, a main pocket, a hand-held tool pocket, a central divider, and reinforcement bands. The hand-held tool pocket attaches to the trapezoidal panel. A reinforcement bands attaches to the top of the hand held tool pocket. The main pocket attaches to this panel and a central divider is inserted to create a total of two deep pockets. A reinforcement band attaches to the top of the main pocket seams. An additional reinforcement band attaches to the sides of this completed panel. A total of four tool pockets and two deep pockets are created.

The Top Panel is made from two rectangular panels, a handle, and four trapezoidal top banding pieces. The top banding pieces attach around the perimeter of the rectangular panel leaving an exposed lip at the top. In leaving this lip creates a tray to temporarily hold fasteners by preventing them from rolling off the side. The handle attaches to the center of the rectangular panel. A foam insert goes between the two main panels.

All panels sewn together will provide the completed Ladder Saddle. A reinforcement band goes around the bottom of the entire completed Ladder Saddle. As well as a total of four internal reinforcement bands to protect the interior seams of the completed sewn product. Four interior panels are added to the inside of the Ladder Saddle for extra durability.

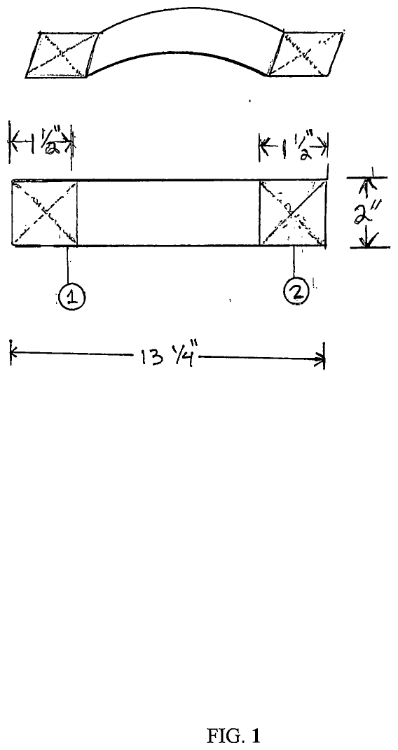

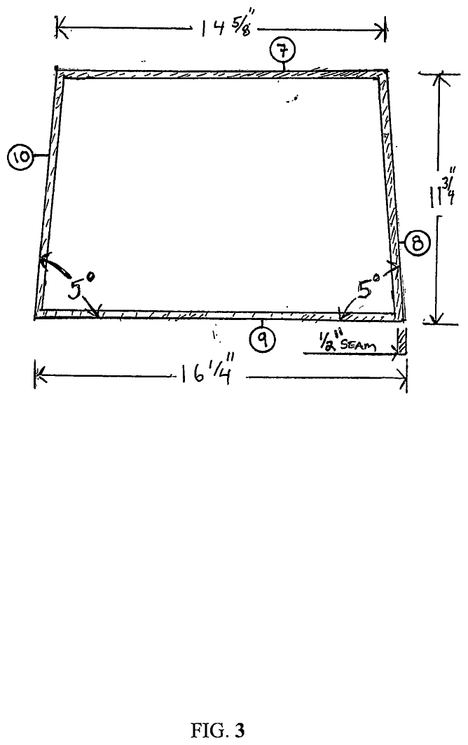

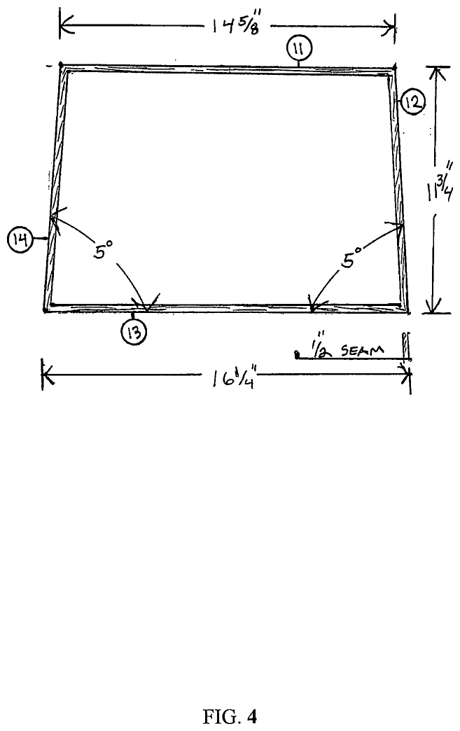

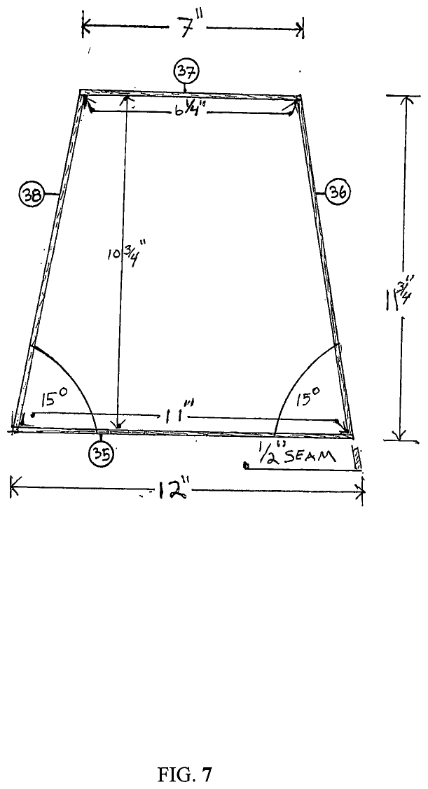

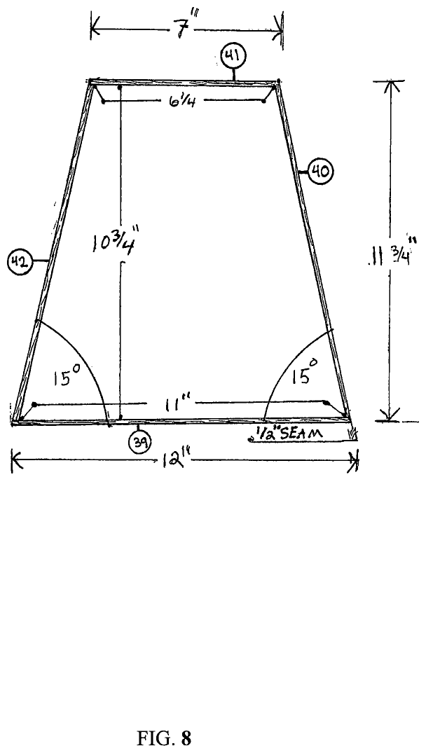

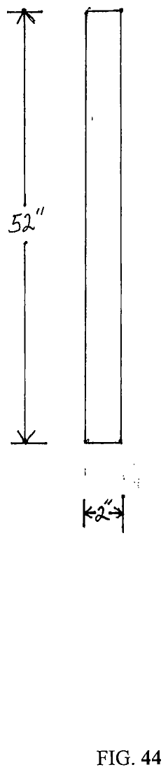

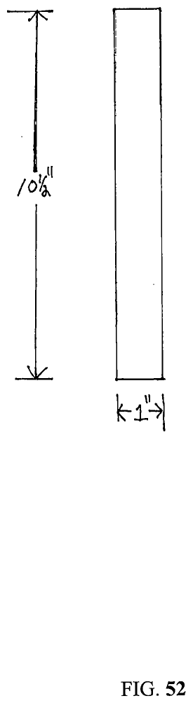

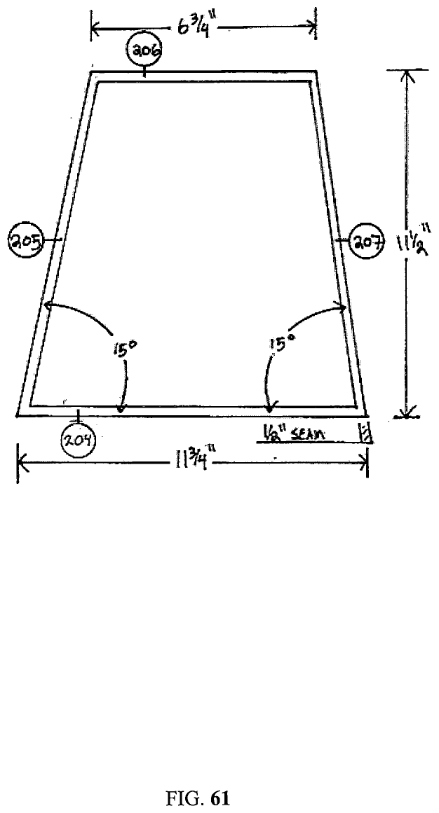

The assembly process is as follows, but is not limited to only this method of sequence. Next will lists the corresponding FIGURES for each panel. The Deep Pocket Panel uses FIGS. 3, 5, 14, 15, 16, 19, 20, 21, 22, 26, 40. To complete the Hammer Holster Panel use FIGS. 7, 11, 12, 25, 33, 35, 38, 39, 66. The Utility Knife Panel needs pieces from FIGS. 8, 10, 24, 28, 29, 30, 31, 32, 36, 37, 42, 43, 65. The Hand-Held Tool Panel will be comprised of FIGS. 4, 6, 9, 13, 17, 18, 23, 27, 41. Lastly, the Top Panel needs FIGS. 1, 2, 24, 25, 26, 27, 59, 60. For the interior reinforcement bands reference FIGS. 52, 53, 54, 55. FIG. 44 is for the bottom reinforcement band. FIGS. 61, 62, 63, 64 are for the second layer for the interior of the main panels.

The next segment will discuss the process for assembly for each designated panel and its corresponding FIGURES. In the drawing sections the seams are numbered and circled.

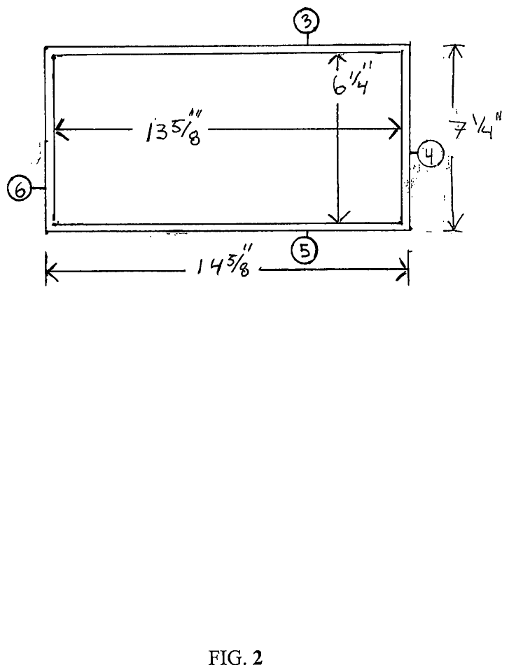

Starting with FIG. 1 and FIG. 2 take FIG. 1 and center it on top of FIG. 2. On both ends of FIG. 1 measure 1½ ″ inches by 2″ inches and sew the perimeter and add an X pattern stitch for heavy duty reinforcement. These two pieces comprise part of the top panel and the handle. The seams are marked with seams 1 and 2 in the drawings.

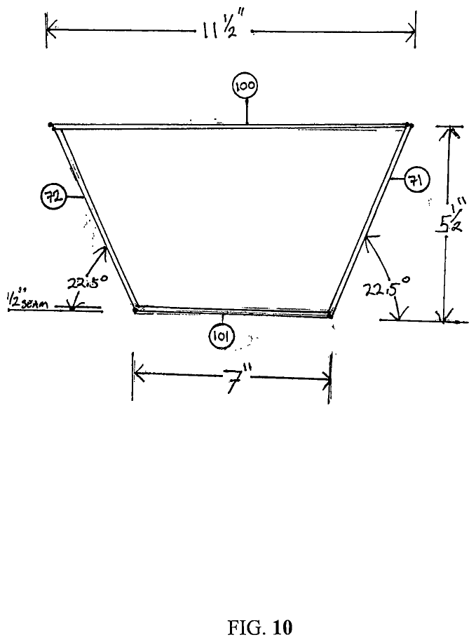

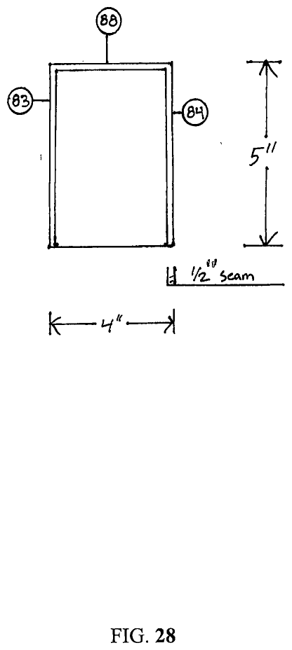

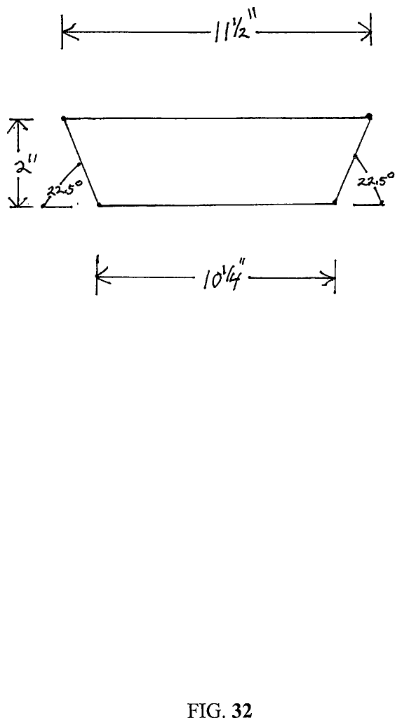

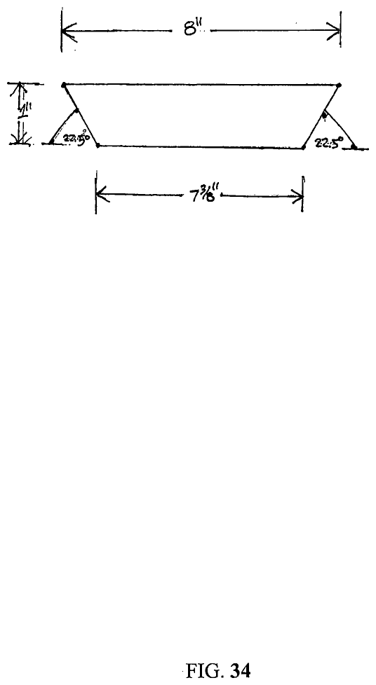

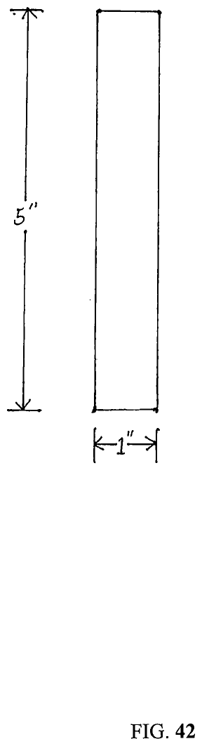

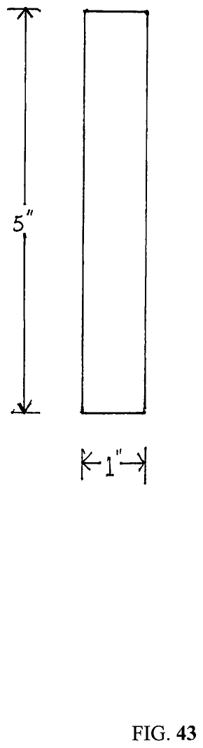

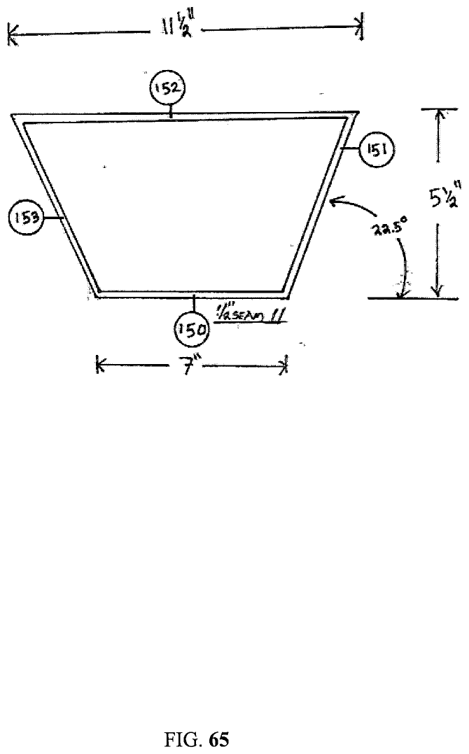

Acquire FIGS. 10, 32, 34, 42, 43, 65 for the holster. The panel uses FIG. 8 and the two Utility Pockets use FIGS. 28, 29, 30, 31, 36, 37. To create the holster fold over ½″ inch seam 152 and seam 150 on FIG. 65 and sew with a heavy duty stitch the entire length of the seam. To the backside FIG. 10 apply FIG. 65 sew seam 153 to seam 72. Sew seam 152 to seam 100. Sew seam 151 to seam 71. Sew seam 150 to seam 101. Sew all seams with heavy duty stitch the entire perimeter. Resulting in a double sided panel for the holster. Take FIG. 10 and place FIG. 32 on the larger side of FIG. 10. On the larger and smaller side of FIG. 10 fold over a ½″ on seams 100 and seams 101 to sew a flat seam. Sew around the entire perimeter of FIG. 32. On the smaller side of FIG. 10 take FIG. 34 and sew around the perimeter. This is now a holster with reinforced upper and lower seams. Use FIGS. 42 and 43 to reinforce the left and right seams. Fold FIG. 42 in half and sew to seam 71. Fold FIG. 43 in half and sew to seam 72. This creates a ½″ reinforcement around the sides of the holster.

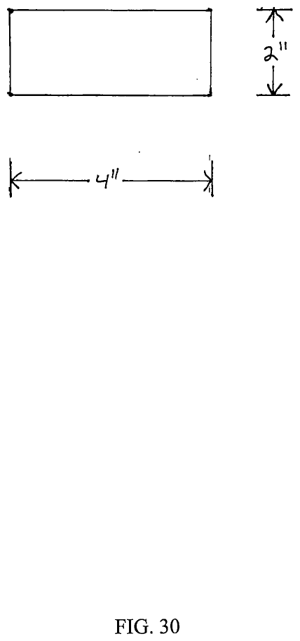

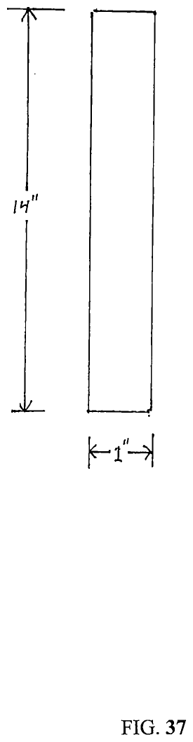

Acquire FIGS. 28, 30, 37. On the top of FIG. 28 fold over a ½″ on seam 88 to create a flat seam. Place FIG. 30 flush to seam 88 of the modify FIG. 28 and sew a heavy duty stitch around the entire perimeter forming a reinforcement band around the top of the utility knife pocket. Now take FIG. 37 and fold in half starting at seam 83 continuing along the bottom working over to seam 84. This creates a ½″ reinforced band around three sides of the utility pocket. FIG. 30 being the top.

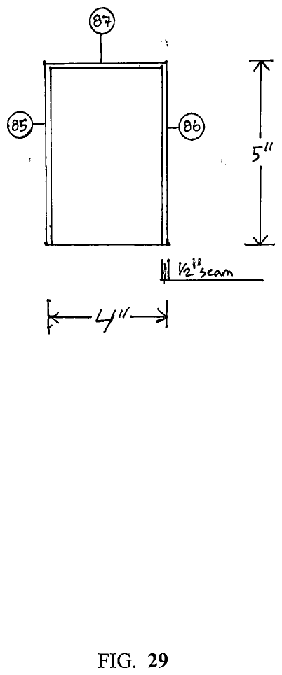

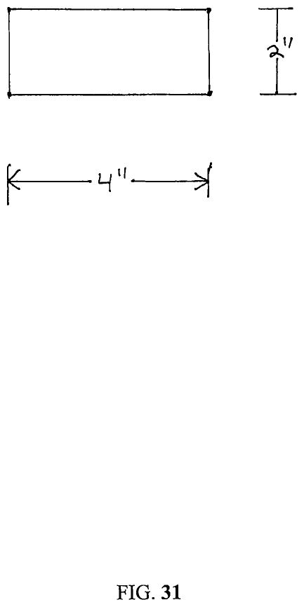

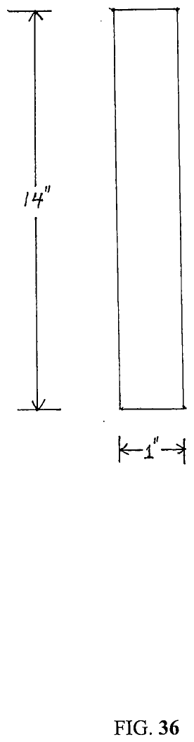

Next acquire FIG. 29, 31, 36. On FIG. 29 fold a ½″ inch on seam 87 and sew to create a flat seam. Place FIG. 31 flush to the top of the new flat seam 87 and sew a heavy duty stitch around the entire perimeter to form a reinforcement band on top of utility knife pocket. Fold FIG. 36 in half and start at seam 85 working around the bottom to seam 86 of the modified FIG. 29. This creates a ½″ inch reinforcement band around the utility pocket. FIG. 31 being the top.

Now take the modified FIG. 28 and sew to the bottom of FIG. 8. Leave bottom ½″ inch seam 39 exposed and leave right side ½″ inch seam 40 exposed. Sew FIG. 29 to bottom of FIG. 8 leaving the left side ½″ inch seam 42 exposed and the ½″ inch bottom seam 39 exposed. On FIG. 28 butt seam 84 to the exposed ½″ inch seam 40. Leave seam 40 exposed. Sew a heavy duty stitch the entire length of seam 84. Push down and in on seam 83 sew a heavy duty stitch to form a utility knife pocket. On FIG. 29 butt ½″ inch seam 85 to ½″ inch seam 42. Leave seam 42 exposed. Sew a heavy duty stitch on entire length of seam 85. Push down and in on seam 86 and sew a heavy duty stitch the entire length of seam 86. This forms two utility knife pockets.

Acquire modified FIG. 10 and the modified FIG. 8. One inch down from the top on the right of seam 41 sew the top of seam 71 in a heavy duty tack. Leaving seam 40 exposed and seam 41 exposed. Sew a heavy duty tack to the top of seam 71. One inch down from the top left side of seam 41 tack sew top seam 72. Leave seam 41 and seam 42 exposed. Sew a heavy duty stitch the entire length of seam 71 and butting to seam 83. Sew a heavy duty stitch the entire length of seam 72 butting to seam 86.

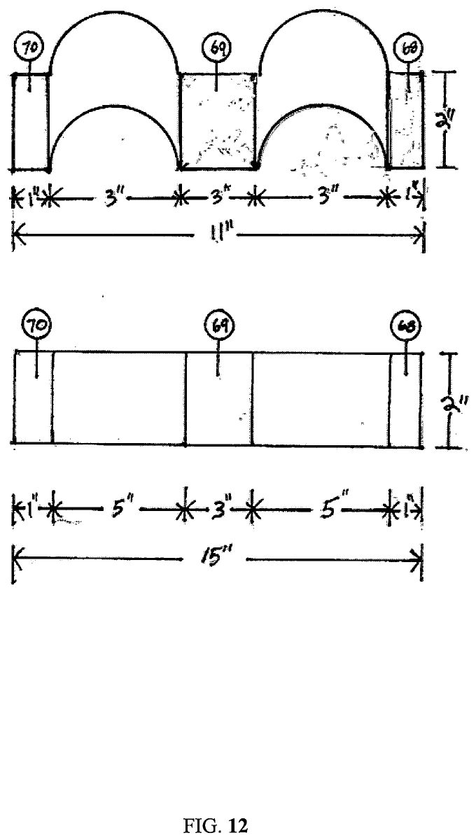

Acquire FIGS. 7, 12, 33, 35, 38, 39. Sew FIG. 12 to the bottom right hand corner of FIG. 7. Sew seam 68 to the bottom right hand corner of FIG. 7 leaving seam 35 and 36 exposed. Seam 68 is 1″ inch by 2″ inch stitch sewn in a heavy duty X pattern style. On FIG. 7 lower left hand side tack sew seam 70 leaving seam 35 and seam 38 exposed. Sew seam 70 in a 1″ inch by 2″ inch heavy duty X pattern. Align seam 69 to bottom center of FIG. 7 leaving ½″ inch seam 35 exposed. Seam 69 is 3″ inch by 2″ inch in heavy a duty X pattern sew around all the perimeter. This forms the heavy duty hammer holders.

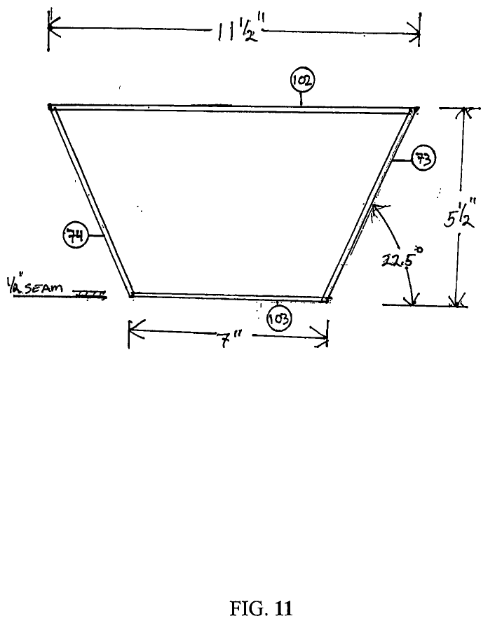

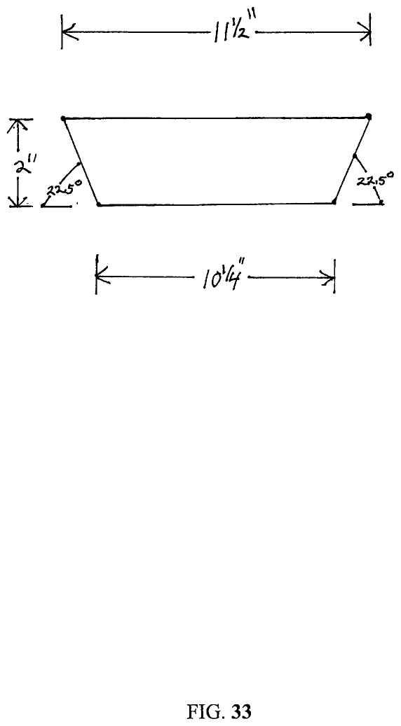

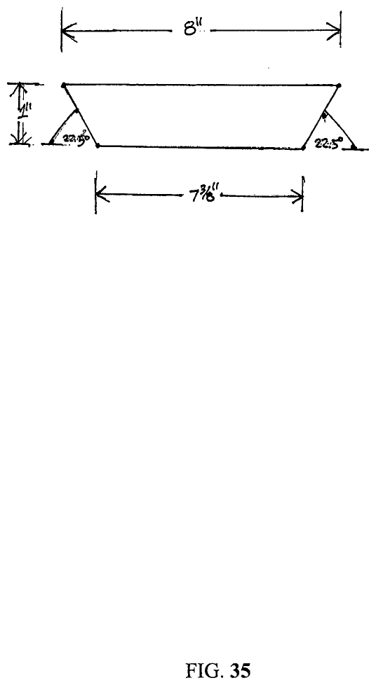

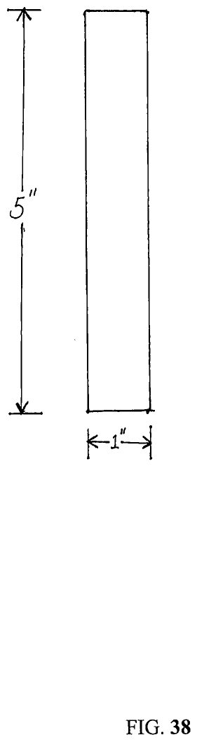

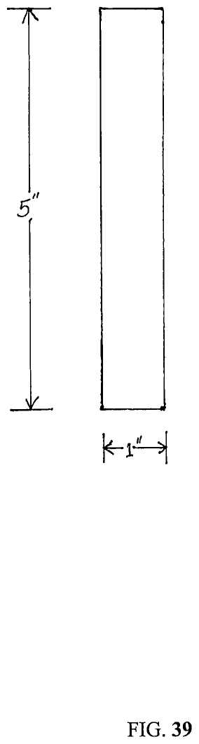

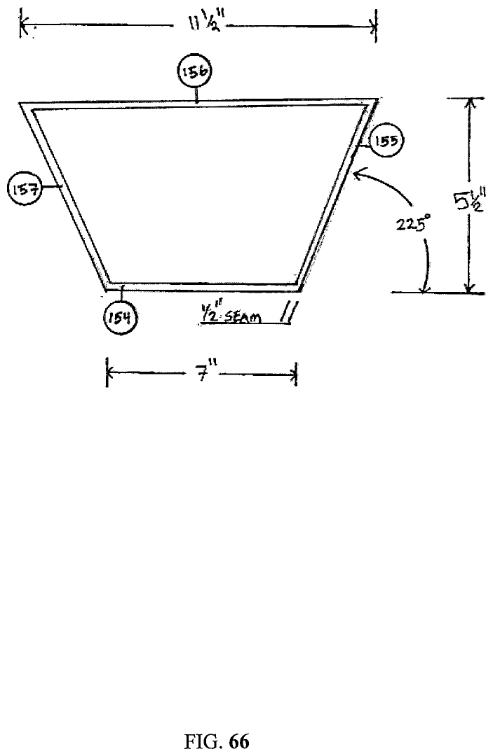

Acquire FIGS. 11, 33, 35, 38, 39, 66. FIG. 66 fold over ½″ inch seams 154 and 156 and sew with a heavy duty stitch along the entire seams. To the back side of FIG. 11 apply FIG. 66 sew FIG. 11 seam 103 to FIG. 66 seam 154. Sew FIG. 11 seam 74 to FIG. 66 seam 157 sew FIG. 11 seam 102 to FIG. 66 seam 156. Sew FIG. 11 seam 73 to FIG. 66 seam 155. Sew all seams with a heavy duty stitch the entire perimeter. The result is a double sided panel for the holster. FIG. 11 fold over and tack sew seam 102 and seam 103. At the bottom of FIG. 11 apply FIG. 35. Sew heavy duty stitch around entire perimeter of FIG. 35. Creating a 1″ inch reinforcement band at the bottom of the holster. Apply FIG. 33 to the top of FIG. 11 sew a heavy duty stitch around entire perimeter of FIG. 33. Fold FIG. 38 in half to create a ½″ inch reinforcement band for the right side of the holster. Sew FIG. 38 to seam 43. Fold FIG. 39 in half and sew to seam 74 to form a ½″ inch reinforcement band for the left side of holster.

Acquire FIG. 7 with FIG. 12 applied and FIG. 11 with FIG. 33 and FIG. 35 attached. Apply FIG. 11 on inch down from the top leaving seam 37 exposed. Tack sew seam 73 of FIG. 11 to top right hand corner of FIG. 7. One inch down from top left hand side of FIG. 7 tack sew seam 74 one inch down from the top leaving seam 37 exposed. Sew seam 73 and 74 around entire perimeter this will form the ½″ inch reinforcement bands for the holster.

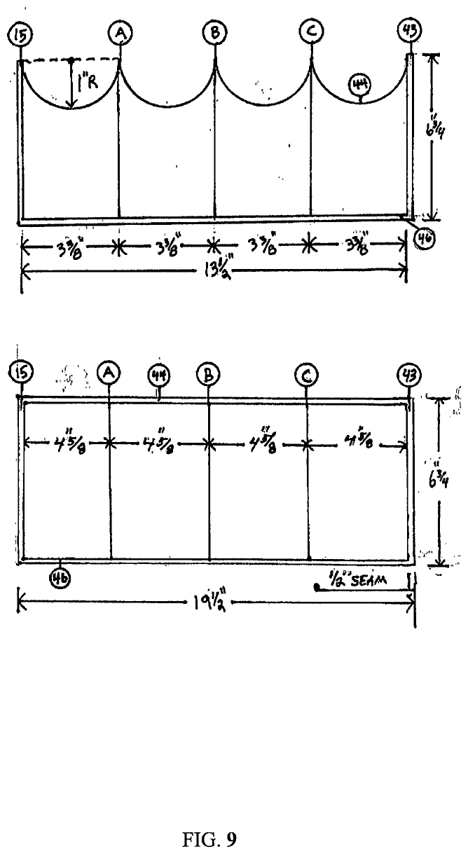

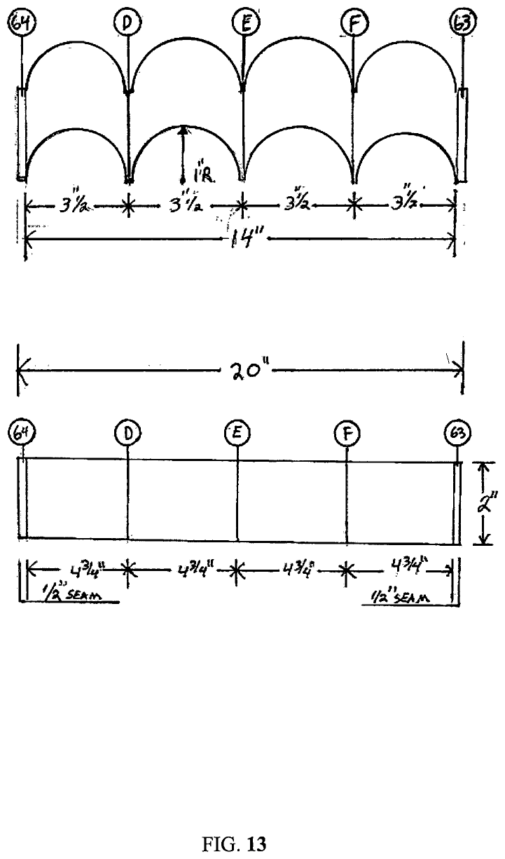

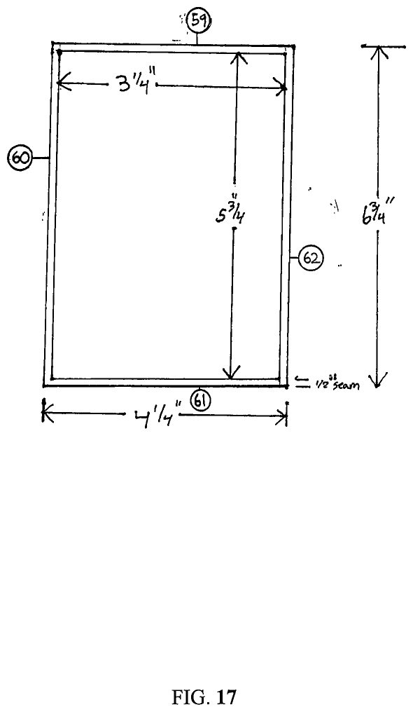

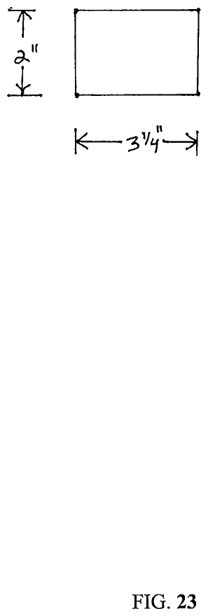

Acquire FIG. 23 and FIG. 17. Fold over ½″ inch seam 59 and sew a straight stitch then with FIG. 23 flush to the top of seam 59 and sew the entire perimeter with a 2″ inch reinforcement band on top of divider. Acquire FIG. 9, modified FIG. 17 and FIG. 13 on FIG. 9 and fold over ½″ inch seam 44 and sew a straight stitch along the seam. Apply FIG. 13 flush to the top of seam 44 and sew a heavy duty stitch along the entire perimeter to form a reinforcement band on top of the hand held tool pocket. Acquire FIG. 4 and the modified FIG. 9. On FIG. 4 place the modified FIG. 9 in the center leaving seam 13 exposed and sew a heavy duty stitch entirety of seam B. From the center measure 3½″ inches to the right and sew another heavy duty stitch on the entire seam C. Again measure 3½″ inches from seam C and sew a heavy duty stitch to seam 43 next to seam 12 leaving seam 12 exposed. Sew the entire seam 43 with a heavy duty stitch. 3½″ inches from seam B sew seam A with a heavy duty stitch and sew the entire seam A. 3½″ inches to the left of seam A sew seam 45 next to seam 14. Leave seam 14 exposed. Sew the entire length of seam 45 with a heavy duty stitch. Sew seam 46 closed. Place FIG. 9 seam 46 to seam 13 on the bottom of FIG. 4. Leave seam 13 exposed. Sew seam 46 the entire length with a heavy duty stitch. This procedure creates the pockets for the four hand held tool pockets. Acquire the modified FIG. 17 place seam 60 on seam B and sew a heavy duty stitch the entire length of seam 60.

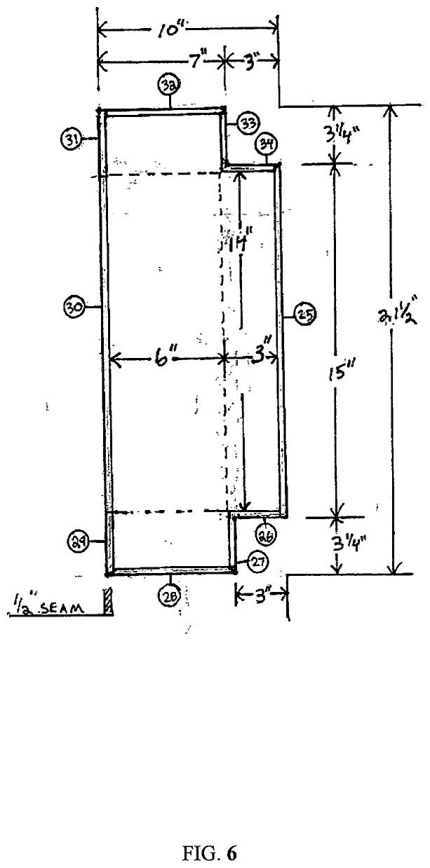

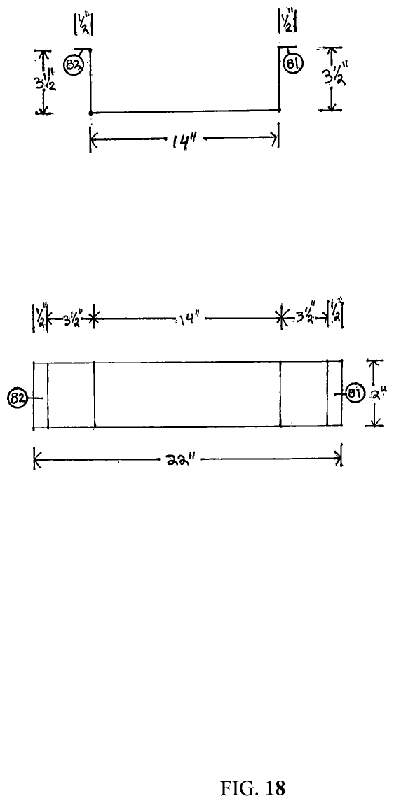

Acquire FIG. 6, FIG. 18, and FIG. 4. On FIG. 6 sew over ½″ inch seams 29, 30, and 31 with a straight stitch along the entire seams. Apply FIG. 18 to top of FIG. 6 flush to seams 29, 30, 31 and sew the entire perimeter of FIG. 18 to create a 2″ inch reinforcement band for pocket of FIG. 6. FIG. 6 on the right ¾″ inch fold line and the bottom 3″ inch fold line join seam 33 and seam 34 with a heavy duty stitch sew the entire seam 33 and seam 34 with a heavy duty stitch. Use a blind seam to attach the modified FIG. 6 to the modified FIG. 4. On the left side of FIG. 6 fold 3¼″ inch line over and using a blind stitch sew together the seam.

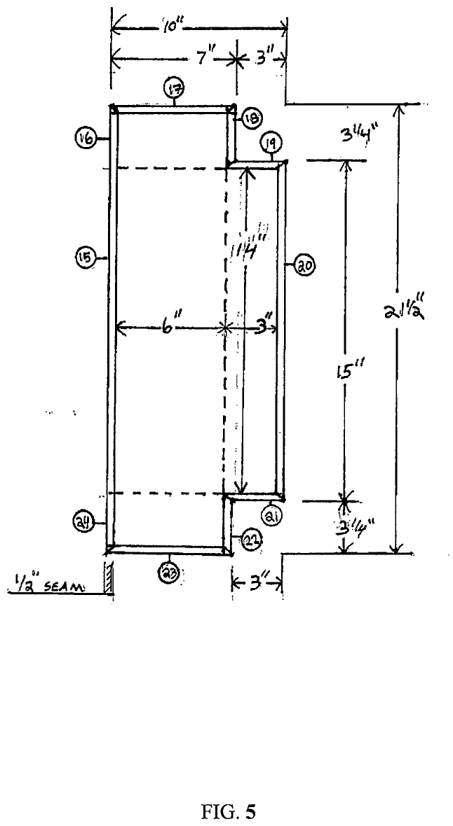

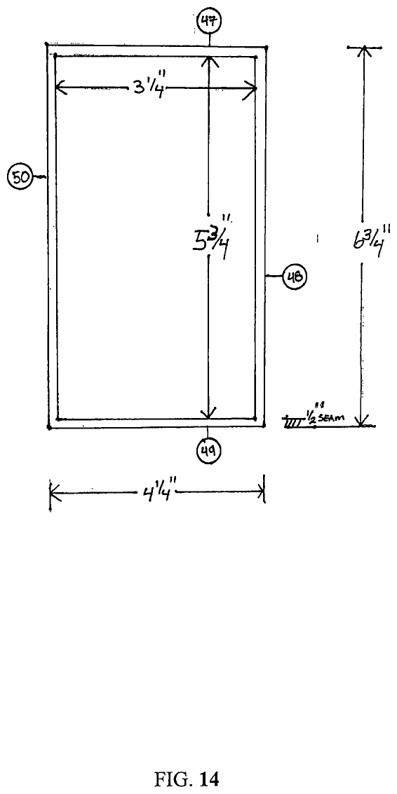

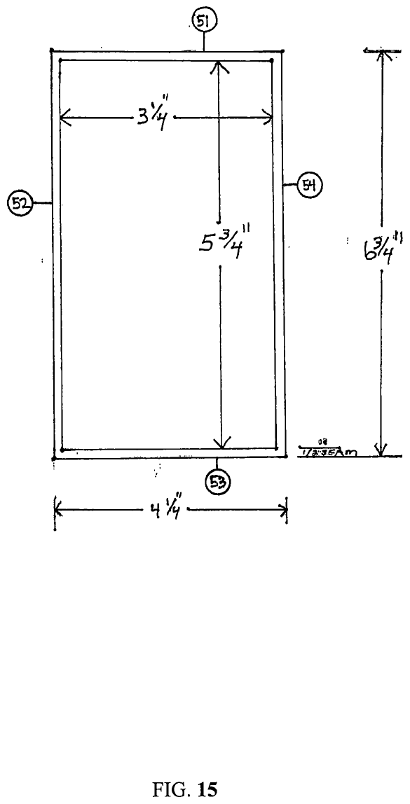

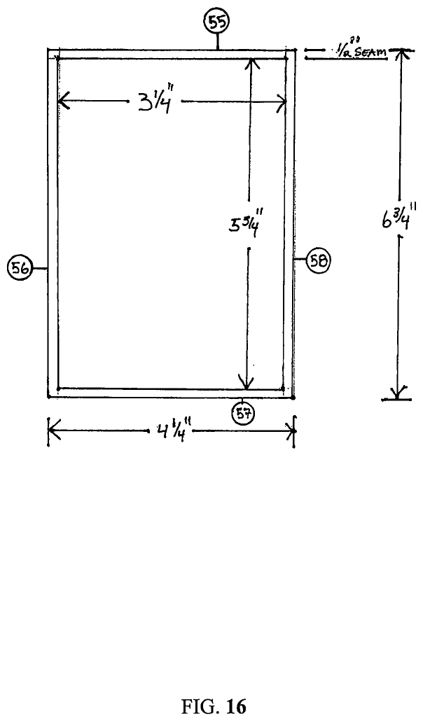

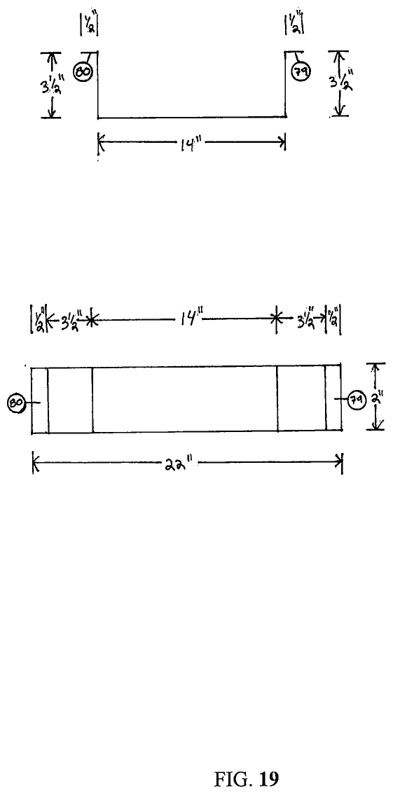

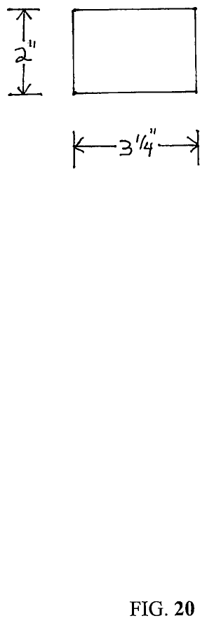

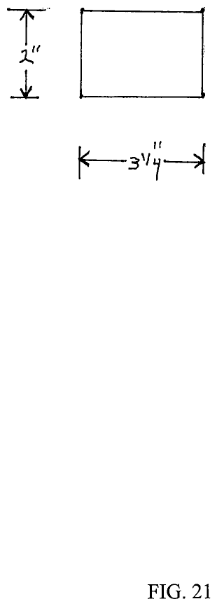

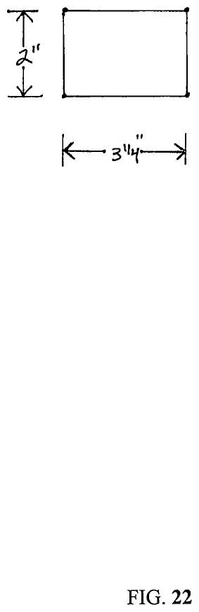

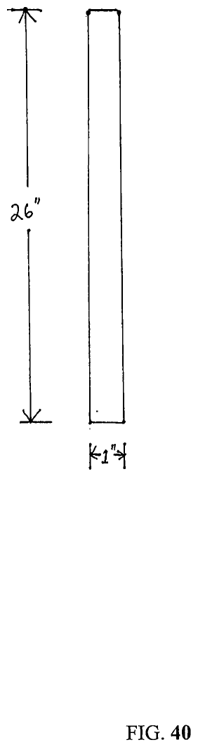

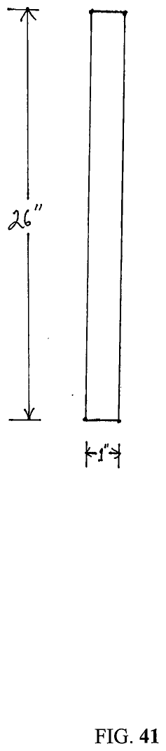

Acquire FIG. 41 fold in half to create a ½″ inch reinforcement band and sew down seam 28 across bottom of seam 25 and up side seam 32. Acquire modified FIG. 4 and modified FIG. 6. On FIG. 6 place seam 28 on top of FIG. 4 seam 43 and sew tack. Place FIG. 6 seam 25 on top of FIG. 9 seam 46 and tack sew. Take FIG. 6 seam 32 and place on top of FIG. 9 seam 45 and tack sew. Now seams are in place center divider FIG. 17 seam 62 sew a heavy duty stitch to FIG. 6 center forming a two pocket divider sew with a heavy duty stitch down seam 32 across seam 25 and up seam 28 to create a panel consisting of two pockets, four hand held tool pockets, with heavy duty reinforcement bands. Acquire FIGS. 3, 5, 14, 15, 16, 19, 20, 21, 22. On FIG. 14 fold over ½″ inch seam 47 and sew a straight stitch the entire seam 47. FIG. 20 applies flush to the top of seam 47. Sew FIG. 20 with a heavy duty stitch the entirety of the perimeter. Fold over ½″ inch seam 51 on FIG. 15 and sew a straight stitch the entire length of the seam. FIG. 21 apply flush to the top of seam 51. Sew a heavy duty stitch to the entire perimeter. FIG. 16 fold over ½″ inch seam 55 and sew a straight stitch the entire seam. FIG. 22 apply flush to the top of seam 55 and sew a heavy duty stitch around the entire perimeter. On the center of panel FIG. 3 apply modified FIG. 15 by attaching seam 54 and leaving ½″ inch seam 9 exposed. Take the modified FIG. 16 and 3½″ inches from the center of FIG. 3 apply seam 58 with a stitch the entire seam. Leave seam 9 exposed and apply the modified FIG. 14 3½″ inches to the left of the center line of FIG. 3. Apply seam 48 and leave seam 9 exposed. FIG. 5 fold over ½″ inch seam 24, seam 15, and seam 16 and sew a straight stitch along the entire length. FIG. 19 apply flush to top of seam 15, seam 16, seam 24 of FIG. 5 and sew a heavy duty stitch around the entire perimeter. This forms a pocket reinforcement band. On FIG. 5 fold up 3 inch fold line and right side 3¾″ inch fold line to join seam 22 and 21 on the inside and sew a heavy duty blind seam. Sew the entire seam. Fold in left side 3¾″ inch side to join seam 18 and seam 19 and sew a heavy duty blind seam. Sew entire seam. Fold FIG. 40 in half sew down to seam 17, across the bottom seam 20, back up to seam 23 of FIG. 5 to create a ½″ inch reinforcement band. On the modified FIG. 5 apply FIG. 15 to the center and stitch seam 53 and the bottom seam 52. Sew both the seams and leave seam 9 exposed. On the center of modified FIG. 5 measure 3½″ inches to the right and apply the modified FIG. 16 sewing seam 56 and seam 57. Sew heavy duty stitch to entire seams and leave seam 9 exposed. On the modified FIG. 5 on the center and measure to the left 3½″ inches and sew FIG. 14 seam 49 and seam 50. Sew the entire seams to FIG. 5. Leave seam 9 exposed.

On FIG. 3 center of the bottom ½″ inch above seam 9 apply modified FIG. 15 seam 54. Sew a heavy duty stitch the entire seam. FIG. 3 off the bottom center line measure 3½″ inches to the right and apply FIG. 16 seam 58. Sew with a heavy duty stitch the entire seam. Off the bottom center line of FIG. 3 ½″ inch above seam 9 measure left 3½″ inches apply FIG. 16 seam 58. Sew a heavy duty stitch the entire seam. FIG. 5 seam 17 butt to FIG. 3 bottom seam 8 leaving seam 8 exposed. Sew a heavy duty stitch the entire seam. FIG. 5 bottom seam 20 butt to bottom of FIG. 3 seam 9, leaving seam 9 exposed. Sew a heavy duty stitch the entire seam. FIG. 5 seam 23 apply to bottom of FIG. 3 butt to the bottom of seam 10 leaving seam 10 exposed sew a heavy duty stitch to the entire seam.

FIG. 8 seam 40 sew to FIG. 4 seam 14 with a heavy duty blind seam stitch. Sew the entire seam. FIG. 4 seam 12 sew to FIG. 7 seam 38 with a heavy duty stitch and a blind seam. Sew the entire seam. FIG. 7 seam 36 sew to FIG. 3 seam 10 using a heavy duty stitch and a blind seam. Sew the entire seam. FIG. 1 seam 4 sew to FIG. 8 seam 41 using heavy duty stitch and blind seam. Sew the entire length of the seam. FIG. 1 seam 3 sew to FIG. 4 seam 11 with a heavy duty stitch and blind seam and sew the entire length of the seam. FIG. 1 seam 6 sew to FIG. 7 seam 37 with a heavy duty stitch and blind seam and sew the entire length of the seam. FIG. 1 seam 5 sew to FIG. 3 seam 7 with a heavy duty stitch with a blind seam and sew the entire seam. FIG. 8 seam 42 sew to FIG. 3 seam 8 with a heavy duty stitch and a blind seam and sew the entire length of the seam.

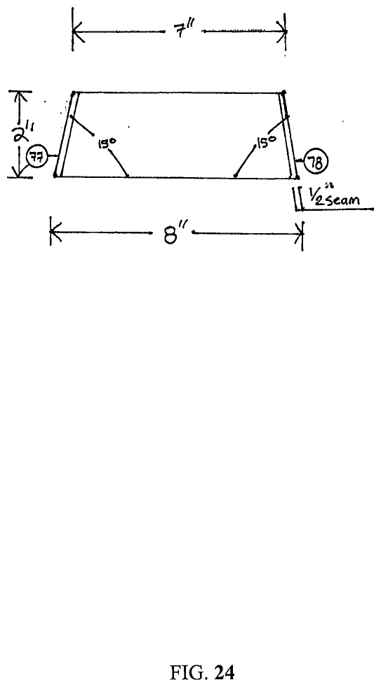

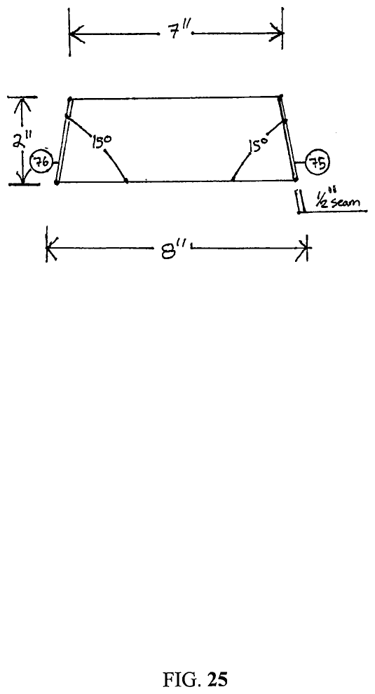

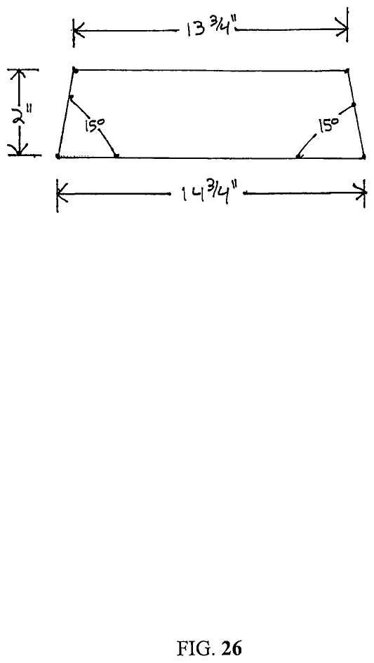

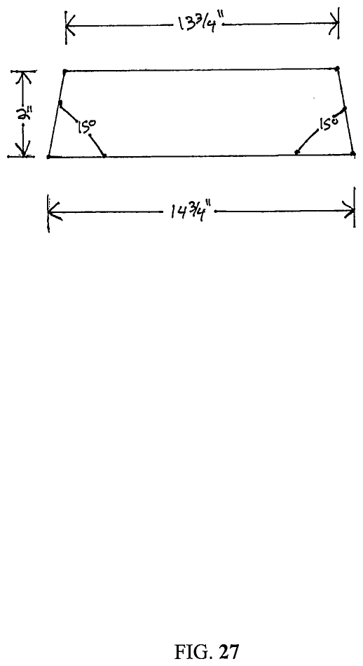

FIG. 24 seam 78 sew to left side of FIG. 27 with a heavy duty stitch and sew the entire seam. FIG. 25 seam 76 sew to the right side of FIG. 27. FIG. 25 seam 75 sew to FIG. 26 on the left side with a heavy duty stitch on the entire seam. FIG. 24 seam 77 sew to the right side of FIG. 26. Apply to the bottom of FIG. 24 to top inch of FIG. 8. Sew a heavy duty stitch 1″ inch X criss cross pattern around the entire length of the seam. Apply to the bottom of FIG. 27 to the top of inch of FIG. 4. Sew a heavy duty stitch 1″ inch X criss cross pattern around the entire length of the seam. Apply to the bottom of FIG. 25 to the top inch of FIG. 7. Sew a heavy duty stitch 1″ inch X criss cross pattern around the entire length of the seam. Apply to the bottom of FIG. 26 to the top one inch of FIG. 3. Sew a heavy duty stitch 1″ inch X criss cross pattern around the entire length of the seam.

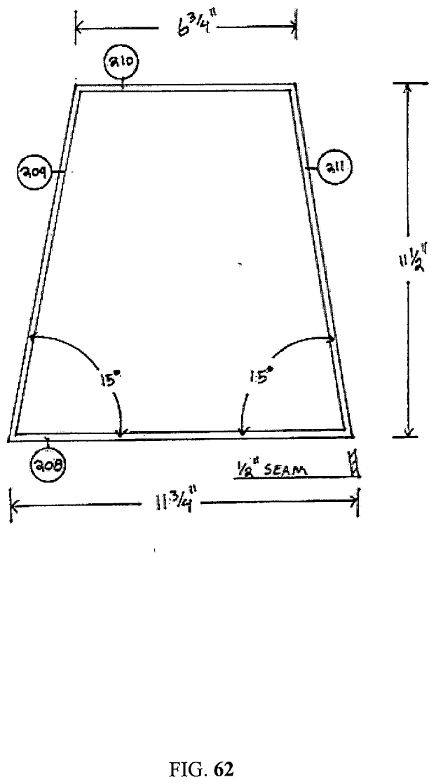

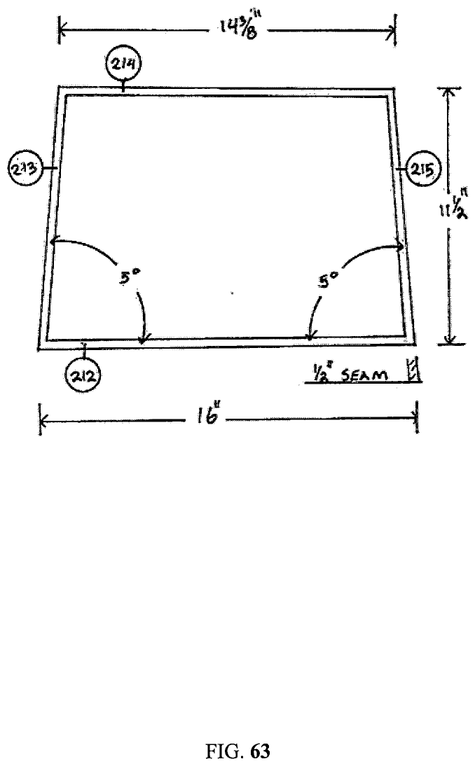

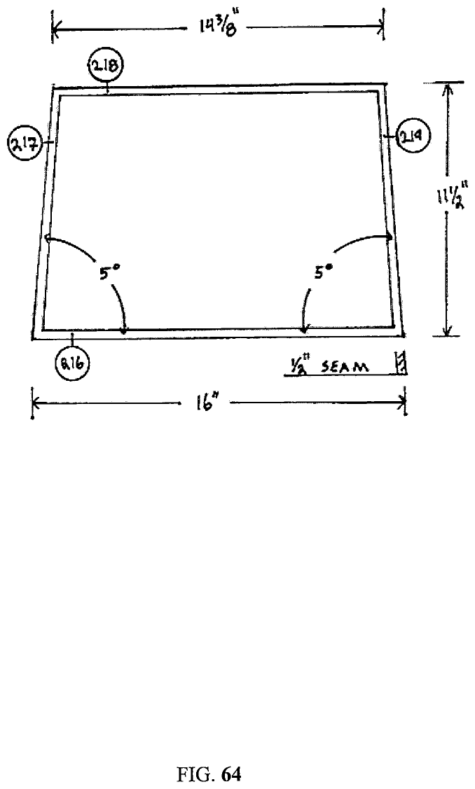

Take FIG. 62 seam 210 and sew to the inside of FIG. 8 at double inside seams 41 and 4. Sew with a heavy duty stitch the entire seam. FIG. 62 seam 209 sew to the inside of FIG. 8 at the double inside seams 40 and 14. Sew with a heavy duty stitch the entire seam. FIG. 62 seam 211 sew to the inside of FIG. 8 at double inside seams 42 and 8. Sew with a heavy duty stitch the entire seam. FIG. 62 seam 208 sew to the inside of FIG. 8 seam 39. Sew with a heavy duty stitch the entire seam. FIG. 64 seam 218 sew to inside of FIG. 3 at double seams 5 and 7 with a heavy duty stitch. Sew the entire seam. FIG. 64 seam 217 sew to inside double seams 8 and 42. Sew with a heavy duty stitch the entire seam. FIG. 64 seam 216 sew to FIG. 3 inside seam 9. Sew with a heavy duty stitch the entire seam. FIG. 64 seem 219 sew to FIG. 3 inside double seams 10 and 36. Sew with a heavy duty stitch the entire seam. FIG. 61 seam 206 sew to FIG. 7 inside double seam 37 and 6. Sew with a heavy duty stitch the entire seam. FIG. 61 seam 207 sew to FIG. 7 inside double seam 36 and 10. Sew with a heavy duty stitch the entire seam. FIG. 61 seam 204 sew to FIG. 7 seam 35. Sew with a heavy duty stitch the entire seam. FIG. 61 seam 205 sew to FIG. 7 inside double seam 38 and 12. Sew with a heavy duty stitch the entire seam. FIG. 63 seam 214 sew to FIG. 4 inside double seam 11 and 3. Sew with a heavy duty stitch the entire seam. FIG. 63 seam 215 sew to FIG. 4 inside double seam 12 and 38. Sew with a heavy duty stitch the entire seam. FIG. 63 seam 212 sew to FIG. 4 inside seam 13. Sew with a heavy duty stitch the entire seam. FIG. 63 seam 213 sew to FIG. 4 inside double seam 14 and 40. Sew with a heavy duty stitch the entire seam.

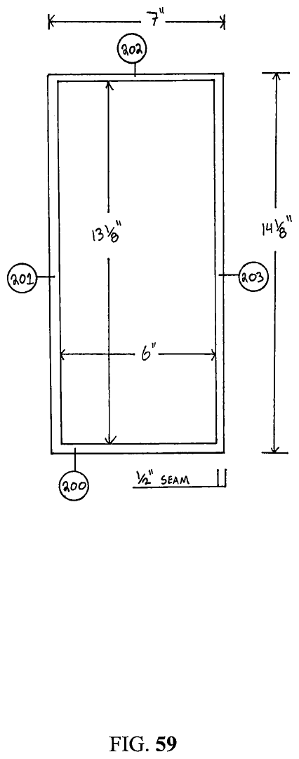

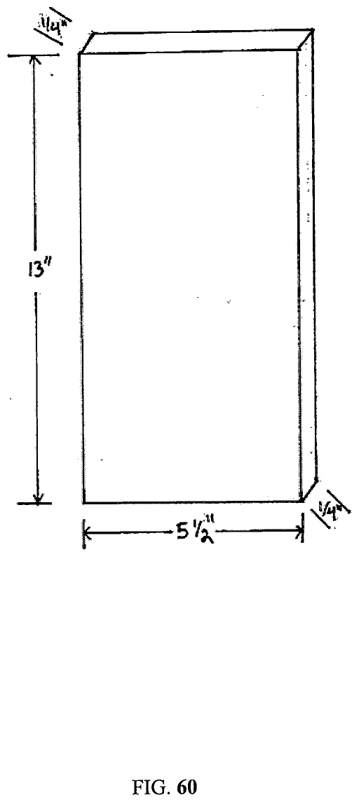

FIG. 59 fold over seam 200, seam 201, seam 202, seam 203 and sew a heavy duty stitch around the entire seams. Take FIG. 60 and apply to inside of FIG. 2 by tack sewing the corners. Take FIG. 59 apply to inside FIG. 2 and over foam FIG. 60 and internal seam 4 and seam 41. Sew with a heavy duty stitch and sew the entire seam. Take modified FIG. 59 sew to inside seam 3 and seam 11 with a heavy duty stitch the entire seam. Take FIG. 59 sew to inside seam 6 and seam 37. Sew with a heavy duty stitch around the entire seam. Modified FIG. 59 sew to seam 5 and seam 7. Sew with a heavy duty stitch and sew the entire seam.

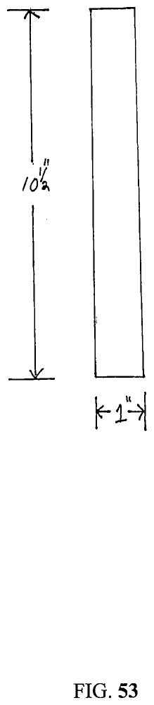

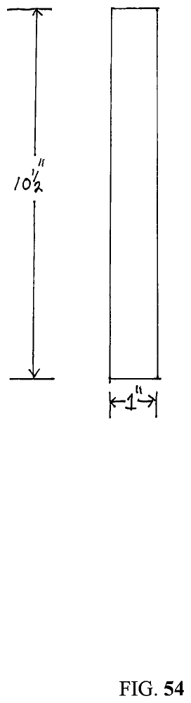

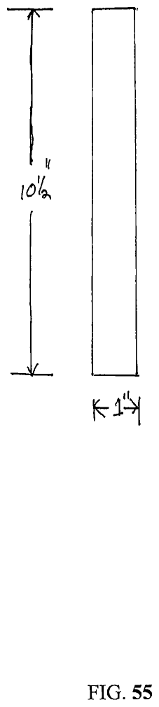

FIG. 52 fold in half and sew to modified inside seam 42 and inside seam 8. Sewn with a heavy duty stitch the entire length of the seam. FIG. 53 fold in half and sew to the modified inside seam 40 and inside seam 14. Sew with a heavy duty stitch the entire length of the seam. FIG. 54 fold in half and sew to the modified inside seam 10 and inside seam 36. Sew with a heavy duty stitch the entire length of the seam. FIG. 55 fold in half and sew to modified inside seam 12 and inside seam 38. Sew with a heavy duty stitch the entire length of the seam.

FIG. 44 fold in half and tack sew to the corner bottom seam 9 and bottom corner of seam 39. Go to corner bottom seam 35 and bottom seam 9 and tack sew the corner. Now go to the bottom seam 13 and bottom seam 35 and tack sew the corner. Now go to the bottom seam 39 and bottom seam 13 and tack sew the corner. FIG. 44 sew entire seam 9, seam 35, seam 13, and seam 39. Sew with a double heavy duty stitch. Sew entire FIG. 44.

1. A sewn tool bag comprised of four trapezoidal panels and a top rectangular panel.
A. As related to claim 1, one of the panels is comprised of a holster and two utility knife pockets; the holster is on the top of the panel and the two utility knife pockets are located on the lower left and right of the panel.
B. As related to claim 1, one of the panels is comprised of a holster and two hammer loops; the holster is the same design as the fore mentioned holster above; the hammer loops are located at the bottom of the panel and the holster is on the top.
C. As related to claim 1, one of the panels is comprised of four pockets with three dividers.
D. As related to claim 1, one of the panels is comprised of four handheld tool pockets and a main pockets with a single central divider.
E. As related to claim 1, seams are reinforced using extra material to prevent abrasive wear on stitching.
F. As related to claim 1, the interior main panels are comprised of secondary panels to double up material.
G. As related to claim 1, a sewn tool bag comprised of the above mentioned panels that are sized to fit A-frame work ladders.

2. The top panel is comprised of two main panels, a handle attached in the center, a foam insert, and a perimeter reinforcement band that leaves a 1″ edge exposed at the top.

3. The holster comprised of four reinforcement bands and a main panel comprised of a heavy duty fabric; the main panel is comprised of two pieces of symmetrical material.
